(19) United States
(12) Patent Application Publication
(10) Pub. No.: US 2023/0006332 A1
(43) Pub. Date: Jan. 5, 2023

(54) MOBILE DEVICE SUPPORTING MIMO

(71) Applicant: Acer Incorporated, New Taipei City (TW)

(72) Inventors: Kun-Sheng CHANG, New Taipei City (TW); Ching-Chi LIN, New Taipei City (TW)

(21) Appl. No.: 17/464,932

(22) Filed: Sep. 2, 2021

(30) Foreign Application Priority Data
Jul. 2, 2021 (TW) 110124349

(51) Int. Cl. H01Q 1/24; H01Q 13/08

(52) U.S. Cl. CPC H01Q 1/243; H01Q 13/085

(57) ABSTRACT

A mobile device supporting MIMO (Multi-Input and Multi-Output) includes a metal mechanism element, a metal sidewall, a first feeding element, a second feeding element, a third feeding element, and a fourth feeding element. The metal sidewall is coupled to the metal mechanism element. A first slot, a second slot, a third slot, and a fourth slot are formed on the metal mechanism element and the metal sidewall. A first antenna structure is formed by the first slot and the first feeding element. A second antenna structure is formed by the second slot and the second feeding element. A third antenna structure is formed by the third slot and the third feeding element. A fourth antenna structure is formed by the fourth slot and the fourth feeding element.

### CROSS REFERENCE TO RELATED APPLICATIONS

This application claims priority of Taiwan Patent Application No. 110124349 filed on Jul. 2, 2021, the entirety of which is incorporated by reference herein.

### BACKGROUND OF THE INVENTION

### Field of the Invention

The disclosure generally relates to a mobile device, and more particularly, it relates to a mobile device and an antenna structure therein.

### Description of the Related Art

With the advancements being made in mobile communication technology, mobile devices such as portable computers, mobile phones, multimedia players, and other hybrid functional portable electronic devices have become more common. To satisfy user demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi and Bluetooth systems and using frequency bands of 2.4 GHz, 5.2 GHz, and 5.8 GHz.

In order to improve their appearance, designers often incorporate metal elements into mobile devices. However, these newly added metal elements tend to negatively affect the operation of antennas used for wireless communication in the mobile devices, thereby degrading the overall communication quality of the mobile devices. As a result, there is a need to propose a novel mobile device with a novel antenna structure, so as to overcome the problems of the prior art.

### BRIEF SUMMARY OF THE INVENTION

In an exemplary embodiment, the disclosure is directed to a mobile device supporting MIMO (Multi-Input and Multi-Output). The mobile device includes a metal mechanism element, a metal sidewall, a first feeding element, a second feeding element, a third feeding element, and a fourth feeding element. The metal sidewall is coupled to the metal mechanism element. A first slot, a second slot, a third slot, and a fourth slot are formed on the metal mechanism element and the metal sidewall. The first feeding element is adjacent to the first slot. A first antenna structure is formed by the first slot and the first feeding element. The second feeding element is adjacent to the second slot. A second antenna structure is formed by the second slot and the second feeding element. The third feeding element is adjacent to the third slot. A third antenna structure is formed by the third slot and the third feeding element. The fourth feeding element is adjacent to the fourth slot. A fourth antenna structure is formed by the fourth slot and the fourth feeding element.

In some embodiments, the metal sidewall is substantially perpendicular to the metal mechanism element.

In some embodiments, each of the first slot, the second slot, the third slot, and the fourth slot is an open slot.

In some embodiments, each of the first slot, the second slot, the third slot, and the fourth slot substantially has an L-shape.

In some embodiments, the mobile device further includes a first metal block wall coupled to the metal mechanism element. The first antenna structure and the second antenna structure are at least partially surrounded by the first metal block wall.

In some embodiments, the mobile device further includes a second metal block wall coupled to the metal mechanism element. The third antenna structure and the fourth antenna structure are at least partially surrounded by the second metal block wall.

In some embodiments, both the first antenna structure and the third antenna structure cover a first frequency band from 600 MHz to 5925 MHz. The second antenna structure covers a second frequency band from 1450 MHz to 5000 MHz. The fourth antenna structure covers a third frequency band from 1710 MHz to 5000 MHz.

In some embodiments, the length of each of the first slot and the third slot is substantially equal to 0.25 wavelength of the lowest frequency of the first frequency band. The width of each of the first slot and the third slot is from 3 mm to 7 mm.

In some embodiments, the length of the second slot is substantially equal to 0.25 wavelength of the lowest frequency of the second frequency band. The width of the second slot is from 3 mm to 7 mm.

In some embodiments, the length of the fourth slot is substantially equal to 0.25 wavelength of the lowest frequency of the third frequency band. The width of the fourth slot is from 3 mm to 7 mm.

### BRIEF DESCRIPTION OF DRAWINGS

The invention can be more fully understood by reading the subsequent detailed description and examples with references made to the accompanying drawings, wherein:

FIG. 1A is a perspective view of a mobile device according to an embodiment of the invention;

FIG. 1B is a perspective view of a mobile device from a viewing angle according to an embodiment of the invention;

FIG. 1C is a perspective view of a mobile device from another viewing angle according to an embodiment of the invention;

FIG. 2A is a perspective view of a mobile device from a viewing angle according to an embodiment of the invention;

FIG. 2B is a perspective view of a mobile device from another viewing angle according to an embodiment of the invention; and

FIG. 3 is a diagram of radiation efficiency of an antenna structure of a mobile device according to an embodiment of the invention.

### DETAILED DESCRIPTION OF THE INVENTION

In order to illustrate the purposes, features and advantages of the invention, the embodiments and figures of the invention are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

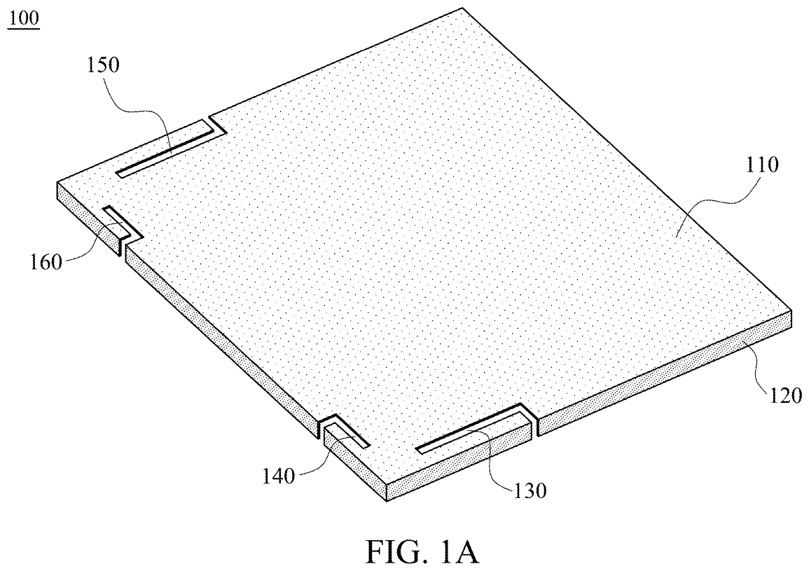

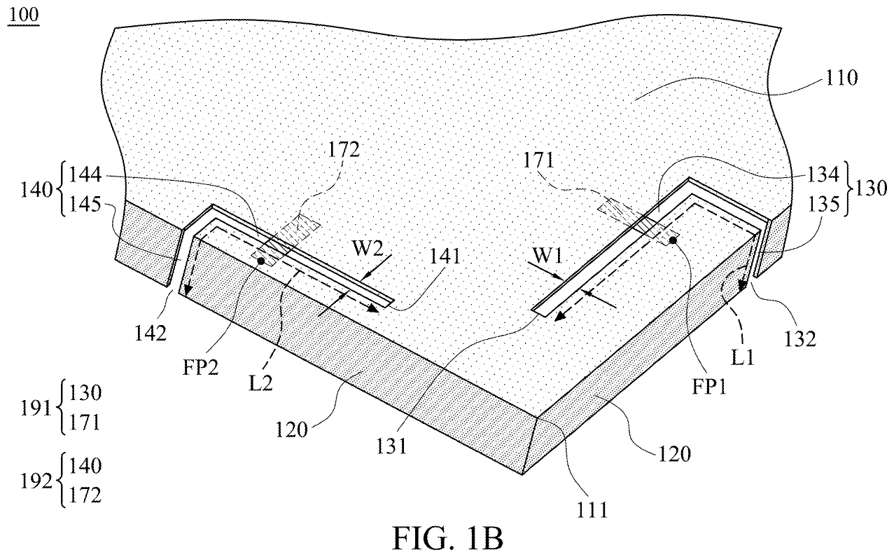

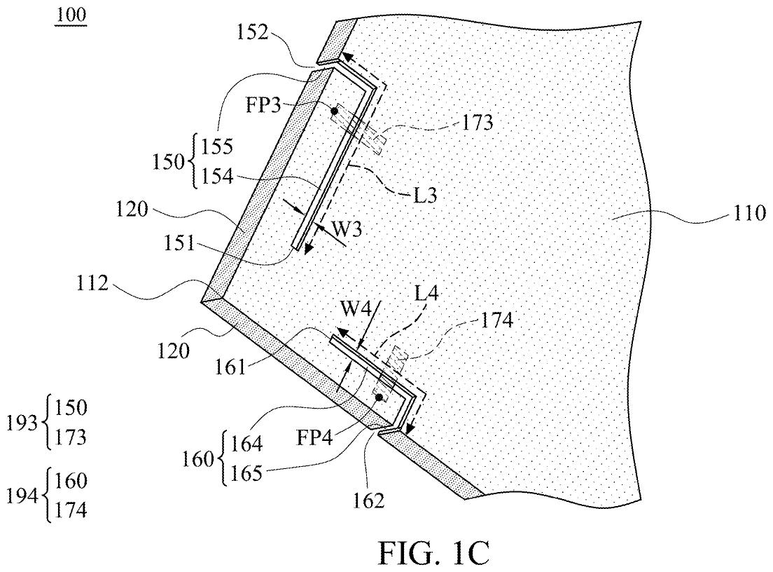

FIG. 1A is a perspective view of a mobile device 100 according to an embodiment of the invention. FIG. 1B is a perspective view of the mobile device 100 from a viewing angle according to an embodiment of the invention. FIG. 1C is a perspective view of the mobile device 100 from another viewing angle according to an embodiment of the invention. Please refer to FIG. 1A, FIG. 1B, and FIG. 1C together. The mobile device 100 may be a smartphone, a tablet computer, or a notebook computer. In the embodiment of FIG. 1A, FIG. 1B, and FIG. 1C, the mobile device 100 includes a metal mechanism element 110, a metal sidewall 120, a first feeding element 171, a second feeding element 172, a third feeding element 173, and a fourth feeding element 174. The first feeding element 171, the second feeding element 172, the third feeding element 173, and the fourth feeding element 174 may all be made of metal materials, such as copper, silver, aluminum, iron, or their alloys. It should be understood that the mobile device 100 may further includes other components, such as a processor, a touch control panel, a speaker, a battery module, and a housing, although they are not displayed in FIG. 1A, FIG. 1B, and FIG. 1C.

The metal mechanism element 110 may be an appearance element of the mobile device 100. It should be noted that the so-called “appearance element” over the disclosure means a portion of the mobile device 100 which eyes of users can directly observe. In some embodiments, the metal mechanism element 110 is a keyboard frame of a notebook computer, but it is not limited thereto. For example, if the mobile device 100 is a notebook computer, the metal mechanism element 110 may be the so-called “C-component” in the field of notebook computers. The metal sidewall 120 is coupled to the metal mechanism element 110. The metal sidewall 120 may be substantially perpendicular to the metal mechanism element 110. A first slot 130, a second slot 140, a third slot 150, and a fourth slot 160 are formed on the metal mechanism element 110 and the metal sidewall 120. For example, each of the first slot 130, the second slot 140, the third slot 150, and the fourth slot 160 may be an open slot, and it may also be considered as a monopole slot.

The first slot 130 may substantially has an L-shape. Specifically, the first slot 130 has a closed end 131 and an open end 132. In some embodiments, the first slot 130 includes a first portion 134 adjacent to the closed end 131 and a second portion 135 adjacent to the open end 132. It should be noted that the term “adjacent” or “close” over the disclosure means that the distance (spacing) between two corresponding elements is smaller than a predetermined distance (e.g., 5 mm or shorter), or means that the two corresponding elements directly touch each other (i.e., the aforementioned distance/spacing therebetween is reduced to 0). The first portion 134 of the first slot 130 may be formed on the metal mechanism element 110. The second portion 135 of the first slot 130 may be formed on the metal sidewall 120. That is, the first slot 130 may extend from the metal mechanism element 110 to the metal sidewall 120. In addition, the first feeding element 171 may substantially have a straight-line shape. The first feeding element 171 has a first feeding point FP1. The first feeding point FP1 may be coupled to a signal source (not shown). The first feeding element 171 is adjacent to the first slot 130 and is below the metal mechanism element 110. A first antenna structure 191 is formed by the first slot 130 and the first feeding element 171. The first feeding element 171 has a first vertical projection on the metal mechanism element 110, and the first vertical projection at least partially overlaps the first slot 130.

The second slot 140 may substantially has an L-shape. Specifically, the second slot 140 has a closed end 141 and an open end 142. In some embodiments, the second slot 140 includes a first portion 144 adjacent to the closed end 141 and a second portion 145 adjacent to the open end 142. The first portion 144 of the second slot 140 may be formed on the metal mechanism element 110. The second portion 145 of the second slot 140 may be formed on the metal sidewall 120. That is, the second slot 140 may extend from the metal mechanism element 110 to the metal sidewall 120. In addition, the second feeding element 172 may substantially have a straight-line shape. The second feeding element 172 has a second feeding point FP2. The second feeding point FP2 may be coupled to the signal source. The second feeding element 172 is adjacent to the second slot 140 and is below the metal mechanism element 110. A second antenna structure 192 is formed by the second slot 140 and the second feeding element 172. The second feeding element 172 has a second vertical projection on the metal mechanism element 110, and the second vertical projection at least partially overlaps the second slot 140. In some embodiments, the closed end 131 of the first slot 130 and the closed end 141 of the second slot 140 are both adjacent to a first corner 111 of the metal mechanism element 110 (e.g., the corresponding distance therebetween may be shorter than 20 mm). According to practical measurements, such a design not only enhances the robustness of the metal mechanism element 110 but also increases the operational bandwidth of the first antenna structure 191 and the second antenna structure 192.

The third slot 150 may substantially has an L-shape. Specifically, the third slot 150 has a closed end 151 and an open end 152. In some embodiments, the third slot 150 includes a first portion 154 adjacent to the closed end 151 and a second portion 155 adjacent to the open end 152. The first portion 154 of the third slot 150 may be formed on the metal mechanism element 110. The second portion 155 of the third slot 150 may be formed on the metal sidewall 120. That is, the third slot 150 may extend from the metal mechanism element 110 to the metal sidewall 120. In addition, the third feeding element 173 may substantially have a straight-line shape. The third feeding element 173 has a third feeding point FP3. The third feeding point FP3 may be coupled to the signal source. The third feeding element 173 is adjacent to the third slot 150 and is below the metal mechanism element 110. A third antenna structure 193 is formed by the third slot 150 and the third feeding element 173. The third feeding element 173 has a third vertical projection on the metal mechanism element 110, and the third vertical projection at least partially overlaps the third slot 150.

The fourth slot 160 may substantially has an L-shape. Specifically, the fourth slot 160 has a closed end 161 and an open end 162. In some embodiments, the fourth slot 160 includes a first portion 164 adjacent to the closed end 161 and a second portion 165 adjacent to the open end 162. The first portion 164 of the fourth slot 160 may be formed on the metal mechanism element 110. The second portion 165 of the fourth slot 160 may be formed on the metal sidewall 120. That is, the fourth slot 160 may extend from the metal mechanism element 110 to the metal sidewall 120. In addition, the fourth feeding element 174 may substantially have a straight-line shape. The fourth feeding element 174 has a fourth feeding point FP4. The fourth feeding point FP4 may be coupled to the signal source. The fourth feeding element 174 is adjacent to the fourth slot 160 and is below the metal mechanism element 110. A fourth antenna structure 194 is formed by the fourth slot 160 and the fourth feeding element 174. The fourth feeding element 174 has a fourth vertical projection on the metal mechanism element 110, and the fourth vertical projection at least partially overlaps the fourth slot 160. In some embodiments, the closed end 151 of the third slot 150 and the closed end 161 of the fourth slot 160 are both adjacent to a second corner 112 of the metal mechanism element 110 (e.g., the corresponding distance therebetween may be shorter than 20 mm). According to practical measurements, such a design not only enhances the robustness of the metal mechanism element 110 but also increases the operational bandwidth of the third antenna structure 193 and the fourth antenna structure 194.

In some embodiments, both the first antenna structure 191 and the third antenna structure 193 can cover a first frequency band from 600 MHz to 5925 MHz, the second antenna structure 192 can cover a second frequency band from 1450 MHz to 5000 MHz, and the fourth antenna structure 194 can cover a third frequency band from 1710 MHz to 5000 MHz. Accordingly, the mobile device 100 can provide a 2×2 MIMO (Multi-Input and Multi-Output) system, and it can support at least the wideband operations of the next-generation 5G communication.

In some embodiments, the element sizes of the mobile device 100 are described as follows. The length L1 of the first slot 130 (i.e., the length L1 from the closed end 131 to the open end 132) may be substantially equal to 0.25 wavelength (λ/4) of the lowest frequency of the first frequency band. The width W1 of the first slot 130 may be from 3 mm to 7 mm. The length L2 of the second slot 140 (i.e., the length L2 from the closed end 141 to the open end 142) may be substantially equal to 0.25 wavelength (λ/4) of the lowest frequency of the second frequency band. The width W2 of the second slot 140 may be from 3 mm to 7 mm. The length L3 of the third slot 150 (i.e., the length L3 from the closed end 151 to the open end 152) may be substantially equal to 0.25 wavelength (λ/4) of the lowest frequency of the first frequency band. The width W3 of the third slot 150 may be from 3 mm to 7 mm. The length L4 of the fourth slot 160 (i.e., the length L4 from the closed end 161 to the open end 162) may be substantially equal to 0.25 wavelength (λ/4) of the lowest frequency of the third frequency band. The width W4 of the fourth slot 160 may be from 3 mm to 7 mm. The above ranges of element sizes are calculated and obtained according to the results of many experiments, and they help to optimize the operational bandwidth and impedance matching of each antenna structure of the mobile device 100.

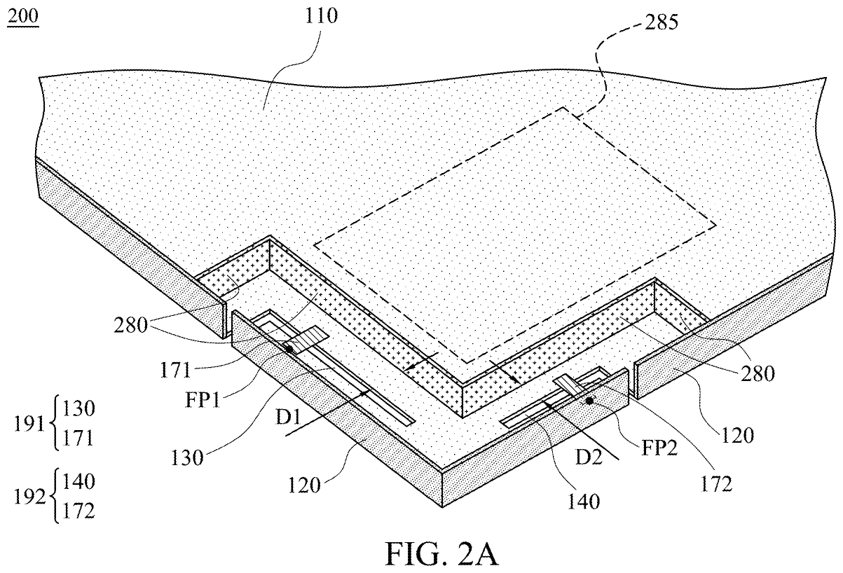

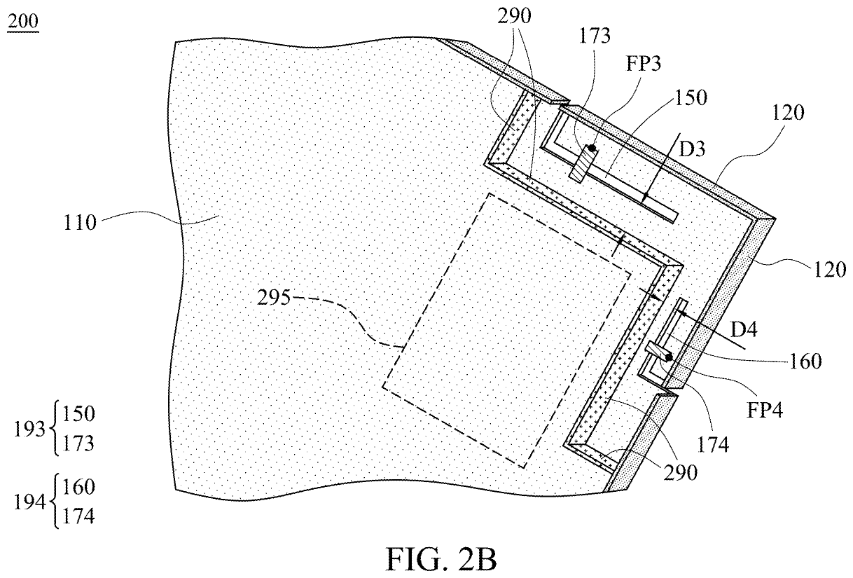

FIG. 2A is a perspective view of a mobile device 200 from a viewing angle according to an embodiment of the invention. FIG. 2B is a perspective view of the mobile device 200 from another viewing angle according to an embodiment of the invention. FIG. 2A and FIG. 2B are similar to FIG. 1A, FIG. 1B, and FIG. 1C. In the embodiment of FIG. 2A and FIG. 2B, the mobile device 200 further includes a first metal block wall 280 and a second metal block wall 290, which are both coupled to the metal mechanism element 110. The heights of the first metal block wall 280 and the second metal block wall 290 are substantially the same as that of the metal sidewall 120. The first antenna structure 191 and the second antenna structure 192 are at least partially surrounded by the first metal block wall 280. In some embodiments, the first antenna structure 191 and the second antenna structure 192 are completely surrounded by the first metal block wall 280 and the metal sidewall 120. The first metal block wall 280 is configured to separate the first antenna structure 191 and the second antenna structure 192 from a first battery placement region 285, so as to remove the noise relative to the battery element. In some embodiments, the distance D1 between the first slot 130 and the first metal block wall 280 may be longer than or equal to 5 mm, and the distance D2 between the second slot 140 and the first metal block wall 280 may be longer than or equal to 5 mm. The third antenna structure 193 and the fourth antenna structure 194 are at least partially surrounded by the second metal block wall 290. In some embodiments, the third antenna structure 193 and the fourth antenna structure 194 are completely surrounded by the second metal block wall 290 and the metal sidewall 120. The second metal block wall 290 is configured to separate the third antenna structure 193 and the fourth antenna structure 194 from a second battery placement region 295, so as to remove the noise relative to the battery element. It should be understood that each of the first metal block wall 280 and the second metal block wall 290 may substantially have a meandering structure, and its detailed shape is not limited in the invention. In some embodiments, the distance D3 between the third slot 150 and the second metal block wall 290 may be longer than or equal to 5 mm, and the distance D4 between the fourth slot 160 and the second metal block wall 290 may be longer than or equal to 5 mm. Other features of the mobile device 200 of FIG. 2A and FIG. 2B are similar to those of the mobile device 100 of FIG. 1A, FIG. 1B, and FIG. 1C. Therefore, the two embodiments can achieve similar levels of performance.

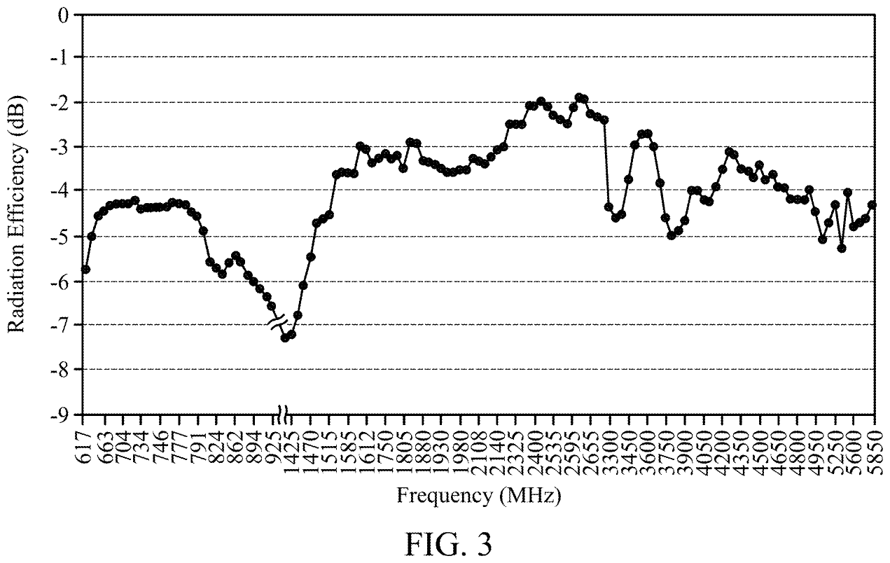

FIG. 3 is a diagram of radiation efficiency of the antenna structure of the mobile device 200 according to an embodiment of the invention. The horizontal axis represents operational frequency (MHz), and the vertical axis represents the radiation efficiency (dB). According to the measurement of FIG. 3, the radiation efficiency of the first antenna structure 191 and the third antenna structure 193 of the mobile device 200 can reach −5 dB or higher within the first frequency band, and it can meet the requirements of practical application of the next-generation 5G communication.

The invention proposes a novel mobile device and a novel antenna structure, which may be integrated with a metal mechanism element. Since the metal mechanism element is considered as an extension portion of the antenna structure, it does not negatively affect the radiation performance of the antenna structure. Compared to the conventional design, the invention has at least the advantages of small size, wide bandwidth, low manufacturing cost, and MIMO characteristics, and therefore it is suitable for application in a variety of mobile communication devices.

Note that the above element sizes, element shapes, element parameters, and frequency ranges are not limitations of the invention. An antenna designer can fine-tune these settings or values according to different requirements. It should be understood that the mobile device and antenna structure of the invention are not limited to the configurations of FIGS. 1-3. The invention may merely include any one or more features of any one or more embodiments of FIGS. 1-3. In other words, not all of the features displayed in the figures should be implemented in the mobile device and antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile device supporting MIMO (Multi-Input and Multi-Output), comprising:
a metal mechanism element;
a metal sidewall, coupled to the metal mechanism element, wherein a first slot, a second slot, a third slot, and a fourth slot are formed on the metal mechanism element and the metal sidewall;
a first feeding element, disposed adjacent to the first slot, wherein a first antenna structure is formed by the first slot and the first feeding element;
a second feeding element, disposed adjacent to the second slot, wherein a second antenna structure is formed by the second slot and the second feeding element;
a third feeding element, disposed adjacent to the third slot, wherein a third antenna structure is formed by the third slot and the third feeding element; and
a fourth feeding element, disposed adjacent to the fourth slot, wherein a fourth antenna structure is formed by the fourth slot and the fourth feeding element.

2. The mobile device as claimed in claim 1, wherein the metal sidewall is substantially perpendicular to the metal mechanism element.

3. The mobile device as claimed in claim 1, wherein each of the first slot, the second slot, the third slot, and the fourth slot is an open slot.

4. The mobile device as claimed in claim 1, wherein each of the first slot, the second slot, the third slot, and the fourth slot substantially has an L-shape.

5. The mobile device as claimed in claim 1, further comprising:
a first metal block wall, coupled to the metal mechanism element, wherein the first antenna structure and the second antenna structure are at least partially surrounded by the first metal block wall.

6. The mobile device as claimed in claim 5, further comprising:
a second metal block wall, coupled to the metal mechanism element, wherein the third antenna structure and the fourth antenna structure are at least partially surrounded by the second metal block wall.

7. The mobile device as claimed in claim 1, wherein both the first antenna structure and the third antenna structure cover a first frequency band from 600 MHz to 5925 MHz.

8. The mobile device as claimed in claim 1, wherein the second antenna structure covers a second frequency band from 1450 MHz to 5000 MHz.

9. The mobile device as claimed in claim 1, wherein the fourth antenna structure covers a third frequency band from 1710 MHz to 5000 MHz.

10. The mobile device as claimed in claim 7, wherein a length of each of the first slot and the third slot is substantially equal to 0.25 wavelength of the lowest frequency of the first frequency band.

11. The mobile device as claimed in claim 1, wherein a width of each of the first slot and the third slot is from 3 mm to 7 mm.

12. The mobile device as claimed in claim 8, wherein a length of the second slot is substantially equal to 0.25 wavelength of the lowest frequency of the second frequency band.

13. The mobile device as claimed in claim 1, wherein a width of the second slot is from 3 mm to 7 mm.

14. The mobile device as claimed in claim 9, wherein a length of the fourth slot is substantially equal to 0.25 wavelength of the lowest frequency of the third frequency band.

15. The mobile device as claimed in claim 1, wherein a width of the fourth slot is from 3 mm to 7 mm.
